(19) United States
(12) Patent Application Publication
(10) Pub. No.: US 2007/0294371 A1
(43) Pub. Date: Dec. 20, 2007

(54) METHOD FOR DETERMINING INPUT FOCUS FOR WEB PAGES HAVING AGGREGATED CONTENT

(76) Inventor: John E. Petri, Lewiston, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/424,324

(22) Filed: Jun. 15, 2006

(51) Int. Cl. G06F 15/16

(52) U.S. Cl. 709/219

(57) ABSTRACT

One embodiment of the invention provides a method for setting an input focus to a user interface element on a web page generated from one or more executable components. The method includes including a focus-designator in a requested webpage, the focus-designator configured to set the input focus to the user interface element when the requested web page is rendered. Also, an executable component may identify a focus priority for one of the user interface elements in the markup content generated by that component.

### BACKGROUND OF THE INVENTION

1. Field of the Invention

The present invention is generally related to user interfaces. More particularly, the present invention is related to a method for determining input focus on web pages composed from multiple, independent page components.

2. Description of the Related Art

Typically, web pages are rendered using markup language content transmitted from a web server to a client. The content for a web page is generally transmitted to the web browser as a single markup document. This approach is well suited for web pages designed to represent a single entity, or content source. Often however, web pages may include markup content generated from many independent components.

For example, a portal web page is a web based application that provides a variety of features, such as personalization, single sign-on, and content aggregation. A portal web page may be generated using several small applications (referred to herein as portlets). Each portlet may be configured to generate a fragment of markup content aggregated into the portal web page. When a portal web page is requested by a client, each portlet may be executed and the resulting page fragments may be aggregated to form a single markup document returned to a requesting client.

The resulting portal page is typically transmitted to the user as an undifferentiated stream of markup content rendered by a web browser at the client. Web portals allow content to be dynamic, responsive to user interaction, and tailored to a particular user. Web portals often include elements which receive user input, such as text fields, buttons, etc. A given element on a webpage may be given “input focus,” meaning the given element is designated as the user interface to which user input is directed. Because each of the portlets on the portal web page is independent from one another, the user interface element that receives input focus may simply be the last one to request input focus when the portal page is rendered. When rendered the markup code for the user interface element may invoke a function setting the focus to that element. For example, one portlet may be configured to set the focus to a specific user interface element on that portlet. If a subsequent portlet also requests the input focus, then the input focus may shift to the user interface element of the subsequent portlet.

This result often leads to a poor user-experience. For example, users often interact with portlets to engage transactions that include a sequence of web pages (e.g., a user may interact with a portlet to perform a multi-step process such as a workflow, wizard, etc. or carry out a commercial transaction such as a consumer purchase). During each step of the process, a user may have to reset the input focus to the appropriate user interface element involved in the transaction. This occurs because another element may have requested the input focus when the page is rendered. Another example includes a portal web page where one portlet is more commonly used than others. In such a case, users may desire the most frequently used portlet to always receive the input focus by default. If that portlet is not the last one included in the portal web page, however, the input focus may subsequently be requested by another, less-important portlet.

Accordingly, there remains a need for a method for determining input focus on web pages composed from multiple, independent page components.

### SUMMARY OF THE INVENTION

One embodiment of the invention includes a method of managing an input focus for user interface elements on a web page. The method generally includes retrieving, in response to a request from a client, a requested webpage that includes one or more references to executable components and generating markup content for each executable component referenced by the requested web page. The method generally further includes aggregating the markup content from each component to form the requested the web page, determining a user interface element on the requested web page to receive input focus, and embedding a client-side script in the requested webpage configured to set the input focus to the user interface element when the requested web page is rendered.

Another embodiment of the invention includes a computer-readable medium containing a program configured to manage an input focus for user interface elements on a requested webpage which, when executed, performs an operation. The operations may generally include generating markup content for one or more executable components referenced by the requested web-page and aggregating the markup content from each executable component to form the requested web page and including a focus-designator in the requested webpage, the focus-designator configured to set the input focus to a designated user interface element when rendering the web page.

Still another embodiment of the invention includes a computing system that includes a web server configured to receive a request for a web page that includes one or more independent components and a portal server. The portal server may be configured to generate markup content for each executable component included on the requested web page, aggregate the markup content from each component to form the requested the web page, determine a user interface element on the requested web page to receive input focus when the requested web page is rendered by the client, and embed a client-side script in the requested webpage configured to set the input focus to the user interface element when the requested web page is rendered.

Yet another embodiment of the invention includes a method for setting an input focus to a user interface element on a web page. The method of this embodiment generally includes generating markup content for one or more executable components referenced by the requested web-page, aggregating the markup content from each executable component to form the web page, and including a focus-designator in the requested webpage, the focus-designator configured to set the input focus to a designated user interface element when rendering the web page.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

Note, however, that the appended drawings illustrate only typical embodiments of this invention and are therefore not to be considered limiting of its scope, for the invention may admit to other equally effective embodiments.

FIG. 1 is an exemplary illustration of a web page composed from multiple, independent components, according to one embodiment of the invention.

FIG. 2 is a conceptual illustration of a client and server system communicating over a computer network, according to one embodiment of the invention.

FIG. 3 is a conceptual illustration of a portal server, according to one embodiment of the invention.

FIG. 4 is a flow chart illustrating a method for responding to a request for a portal web page composed from multiple, independent components, according to one embodiment of the invention.

FIG. 5 is flow chart further illustrating a method for responding to a request for a web page, according to one embodiment of the invention.

FIGS. 6A-6B illustrate an exemplary portal web page showing changes to input focus before and after login transaction performed using a login portlet, according to one embodiment of the invention.

### DETAILED DESCRIPTION OF THE PREFERRED EMBODIMENTS

Embodiments of the invention are directed to a common usability problem in web pages, especially in web pages composed from multiple, independent components (referred to herein as a “portal web page” or just “portal”). More specifically, embodiments of the invention are directed to a method for managing input focus on a portal web page. That is, to managing which user interface element on the portal web page receives the input focus when the portal web page is rendered. According to one embodiment, the term input focus refers to the user interface element on a webpage where user input is directed. While a user interface element has the input focus, that element may determine how to respond to any user interaction with that element.

Typically, a portal web page includes content aggregated from multiple, independent web applications (referred to herein as “portlets”). Embodiments of the invention allow input focus for the portal web page to be managed in an intuitive manner, consistent with user expectations. Further, this result may be achieved even though the portlets included on a given portal web page may be generally unrelated to one another.

In one general embodiment, the user interface element for a portal web page given input focus may be set administratively. In another general embodiment, a portlet may identify a focus priority for one of the user interface elements included in markup content generated by that portlet. When content from one or more portlets is aggregated to generate the portal web page, the administrative focus priority (if any) and the focus priority identified by one or more portlets (if any), or both, may be evaluated to select which user interface element of the portal web page should receive the input focus. Additionally, a client-side script may be included with the portal web page to set the input focus to this user interface element when the page is rendered by a client.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

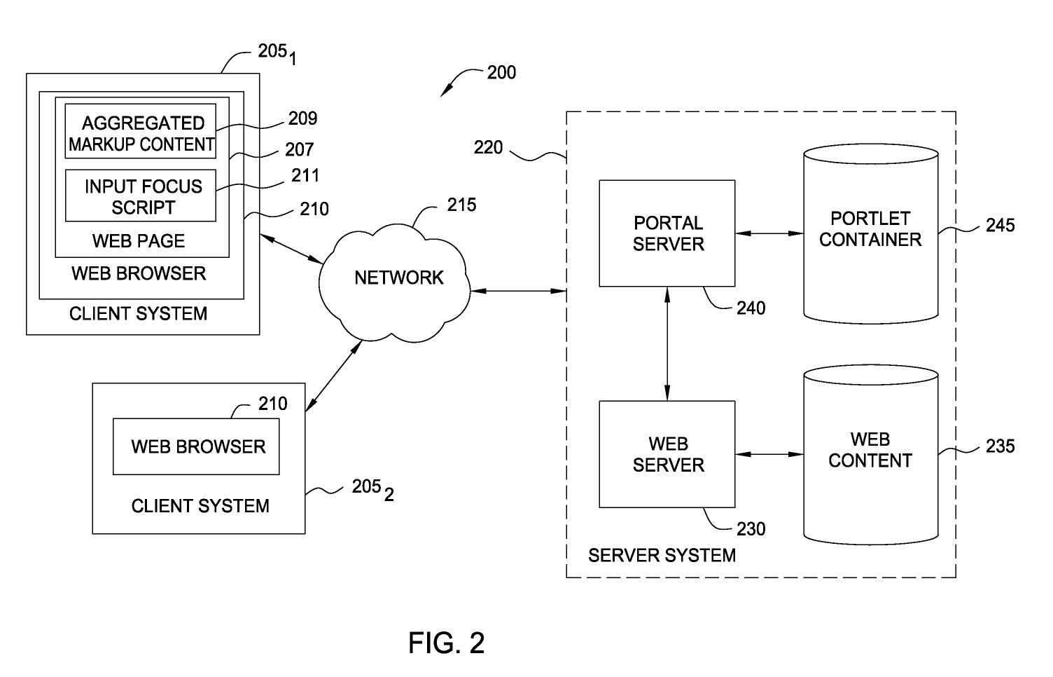

One embodiment of the invention is implemented as a program product for use with a computer system such as, for example, the computing environment 200 shown in FIG. 2 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD/DVD-ROM disks readable by a CD/DVD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

In general, the routines executed to implement the embodiments of the invention, may be part of an operating system or a specific application, component, program, module, object, or sequence of instructions. Computer programs of the present invention typically are comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

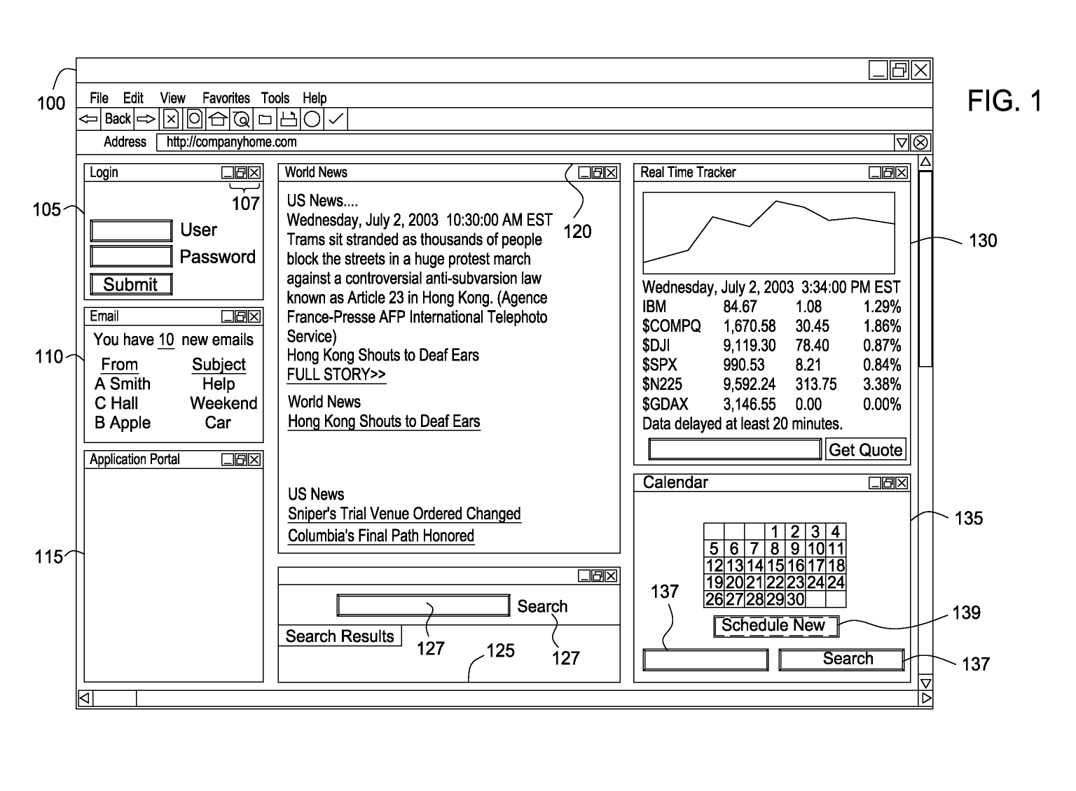

FIG. 1 illustrates the components of an exemplary portal web page 100, according to one embodiment of the invention. As shown, portal web page 100 displays a single markup document that aggregates content generated for several portlet windows. Illustratively, portal web page 100 include a login portlet 105, a weather information portlet 110, a web-application portlet, 115, a news information portlet 120, an information search portlet 125, a real time stock tracking portlet 130, and a calendar portlet 135. In addition to portlets 105-135, portal web page 100 may also include additional navigation areas and banners, and other markup content aggregated with markup content generated by a portlet.

Illustratively, each portlet 105-135 is rendered in a portlet window that includes a title bar, portlet title, user interface elements, and the content for the portlet. The user interface elements may include buttons to change a portlet window state, (e.g., the maximize, minimize, and help buttons 107 of login portlet 105). Further, portlets 105-135 may include user interface elements allowing a user to interact with a given portlet. For example, information search portlet 125 and calendar portlet 135 each include a text field for entering search terms and search buttons 127 and 137 used to submit a search request. Similarly, login portlet 105 includes text fields for a user to input a user name and password. The varied content of portlets 105-135 illustrates how portal web page 100 may include content aggregated from variety of unrelated sources.

As shown, the input focus for portal web page 100 is currently set to a button 139 of the calendar portlet 135 labeled “schedule new”. As shown, the dashed lines around button 139 are used to indicate that this user interface element currently has the input focus for portal web page 100. In this example, with the input focus set to the button 139, any key presses are directed to this element. The button 139 may be configured to disregard any keys pressed by a user, other than a space bar or return key, which may be interpreted as the user “pressing” button 139. Similarly, if the input focus is set to the text field 137, (e.g., by clicking a mouse cursor in the region bounded by text field 137) user input is directed to this user interface element. When this occurs, a blinking caret may be displayed, and any text input by a user will be displayed text field 137. Of course, in addition to text boxes and buttons, a portlet on portal web page 100 may include a variety of other user interface elements.

FIG. 2 is a conceptual illustration of computing environment 200 that includes client and server systems communicating over a computer network 215, according to one embodiment of the invention. As shown, computing environment 200 includes two client systems 205, and 2052 communicating over network 215 with server system 220.

Client systems 2051, 2052, and server system 220 provide a simplified representation of a variety existing computer systems, e.g., desktop computers, server computers, laptop computers, tablet computers, and the like. Additionally, the client systems may be representative of other computing devices such as PDA's and WML enabled mobile phones. The invention, however, is not limited to any particular computing system and may be adapted to take advantage of new computing systems and devices as they become available. Network 215 may represent any suitable network, including small local area networks, corporate intranets, large wide area networks such as the Internet, or any combination thereof.

As shown, client systems 205, and 2052 include a web browser application 210 configured to request a portal web page (e.g., page 100 of FIG. 1) from a web server 230. Common examples of web browser applications include the Internet Explorer® web browser available from Microsoft® and the Firefox® web browser available from the Mozilla® foundation. However, embodiments of the invention may be used with other applications running on client systems 205 that are configured to request a portal webpage from web server 230.

Illustratively, web browser 210 on client system 205, includes a portal webpage 207. The portal web page 207 may includes aggregated content 209 generated for multiple portlets, as well as any static content (e.g., any additional text, navigation areas, and banners, and the like) included in portal web page 207. Additionally, portal web page 207 includes an input focus script 211. As described in greater detail below, input focus script 211 may be added when portal web page 207 is generated. Input focus script 211 may be configured to set the input focus when portal web page 207 is rendered on web browser 210 to an element determined by the portal server 240. In one embodiment, the input focus script may be composed in the javascript client-side scripting language. However, other client-side scripting languages or techniques may be used.

As shown, server system 220 includes web server 230, web content 235, a portal server 240 and a portlet container 245. For simplicity, web server 230 and portal server 240 are both shown as a part of server system 220. One of ordinary skill in the art will recognize, however, that web server 230 and portal server 240 may be running on separate computer systems.

The web server 230 provides a computer software application generally configured to respond to requests for web pages available from web content 235. In one embodiment, a web page may include references to one or more portlets. For example, a web page may include Java Server Pages (JSP) tags specifying where to place content from a particular portlet into a page. A JSP tag may further identify which portlet should be invoked, and any parameters that should be passed to the portlet.

Portal server 240 provides the software application framework for invoking portlets and generating the dynamic content for a portal web page. Portal server 240 may also provide a variety of tools and functions, including tools for user authentication and identity management, a search facility, and tools for content aggregation. Portal server 240 may provide personalization features to provide customized content to users. In one embodiment, the WebSphere® portal server available from IBM® of Armonk, N.Y. may be used.

When web server 230 receives a request for a portal web page, it may be configured to request content for portlets included on the requested web page from portal server 240. In response, the portal server 240 may be configured to invoke the appropriate portlets and aggregate content into a complete markup document returned to the requesting client 205. Additionally, in one embodiment, the portal server 240 may also be configured to evaluate an administrative focus priority (if any) specified for a portal web page. Portal server 240 may also evaluate an input focus priority returned with the markup content from one (or more) of the portlets. Together, the administrative focus priority and portlet specified focus priorities may be used to determine which user interface element will receive the input focus when the portal web page is rendered by client web browser 210.

Portlet container 245 provides the runtime environment for a portlet. Typically, portlet container 245 provides a Java virtual machine execution environment in which to invoke and run a portlet. Portlet container 245 may also provide persistent storage mechanisms for sessions between a particular client 205 and a particular portlet. For example, portlet container 245 may allow an instance of a portlet to provide persistent data values as a user performs a transaction requiring multiple steps.

As stated, a portlet may return a focus priority for one of the user interface elements included in the markup content generated for the portlet. In one embodiment, a portlet may be configured to specify a numerical focus priority, (e.g., a scale from 1-10). Alternatively, a portlet may specify a focus priority using categories such as “low” “normal” and “high.” By specifying a priority for a user interface element, a portlet may be able to retain focus throughout a multi-step transaction. For example, a portlet-specified focus priority of “in progress transaction—focus required” could be used to override a default focus priority assigned to a user interface element of a given portal web page. Of course, the particular metric used to specify focus priority for user interface elements of a portlet may be tailored to suit the needs in a particular case.

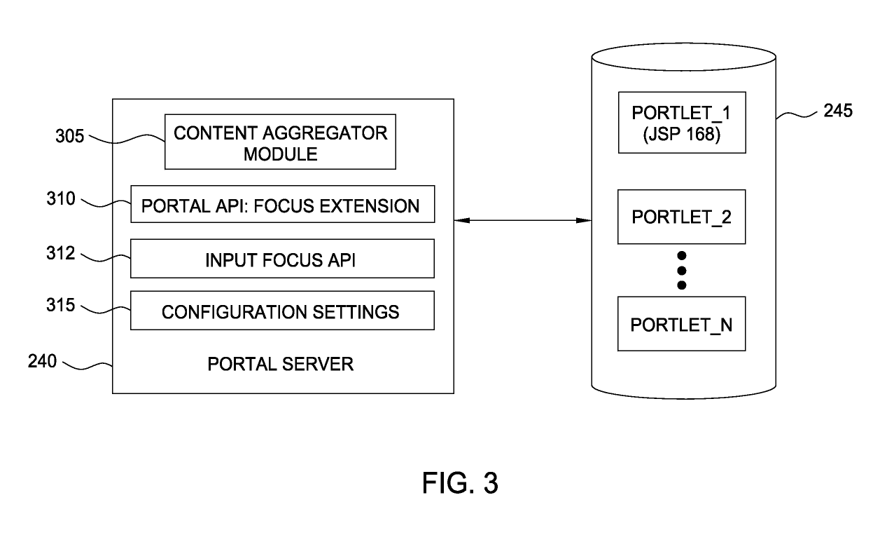

FIG. 3 is a block diagram further illustrating portal server 240, according to one embodiment of the invention. As shown, the portal server 240 includes a content aggregation module 305, a portal API 310, input focus API 312, and configuration settings 315. As stated, portal server 240 may be configured to invoke each portlet to execute inside portlet container 245. As shown, container 245 includes three portlets, however, any number of portlets may execute within the runtime environment provided by container 245.

Portal API 310 may provide a set of interfaces and methods used by portlets invoked within portal container 245. The portlet API may be provided with portal server 240. In one embodiment, the portlets may be composed according to the Java Specification Request 168 (JSR168) Portlet Specification. The JSR168 specification provides a portlet specification that includes a set of APIs that enable interoperability between different portal servers 240 and portlets composed according to the JSR168 specification. The JSR168 Portlet specification also addresses security and personalization aspects of portlets.

Input focus API 312 may provide a set of interfaces and methods that allow a portlet to specify a focus priority for a user interface element on the portlet. In one embodiment, input focus API 312 may be provided as an extension of the portlet API 310. For example, the input focus API 312 may extend the API defined by the JSR168 Portlet specification or the IBM portlet API provided with IBM WebSphere® portal serer 240.

Configuration settings 315 may be used to specify an input focus for a user interface element of a portal web page. In other words, configuration settings 315 may allow an administrator to specify which user interface element of a portlet should receive input focus when the portal web page is rendered by client web browser 210. For example, configuration settings 315 may specify a default element that should receive the input focus. Such a setting may be used to anticipate user expectations regarding which element of the portal webpage should receive input focus, both initially, and while a user engages is in a multi-step transaction that involves a sequence of web pages.

Configuration settings 315 may take the form of simply specifying a default user interface element or may also provide more complex rules used to evaluate which user interface element should receive the input focus when a portal web page is rendered. For example, a default focus may specify that the username of a login portlet should receive the input focus unless a user is already logged in, in which case a text field for entering search terms should receive the input focus. Such a rule could further specify that if a user is engaging in a multi-step transaction with a particular portlet on a portal web page, an element of that portlet should receive focus during each intermediate step of the transaction.

Configuration settings 315 may also use the focus priority returned by the portlets to select which user interface element should be given focus priority. For example, configuration settings 315 may specify a default user interface element to receive input focus, unless a portlet returns a “HIGH” priority for one of its user interface elements, in which case the user interface element with the “HIGH” priority receives the input focus. More generally, portal server 340 may evaluate administrative focus priority specified in configuration settings 315 (if any) and the focus priority identified by one or more portlets (if any), or both, to select which user interface element of a portal web page should receive the input focus when the portal webpage is rendered.

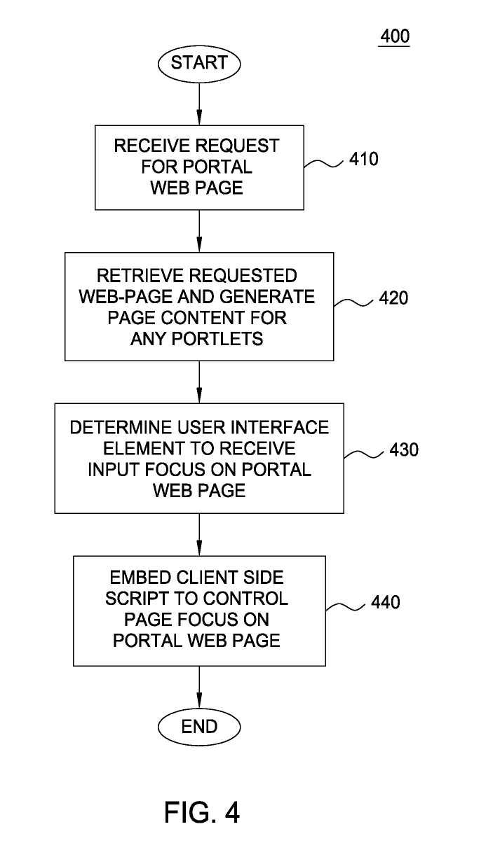

FIG. 4 is a flow chart illustrating a method 400 for setting the input focus on a portal web page, according to one embodiment of the invention. The method begins at step 410 where a client (e.g., web browser 210 of FIG. 2) submits a request for a portal web page to web server 230. In response, the web server 230 retrieves the requested web page from web content 235 and requests content for each portlet included in the requested web page from portal server 240. As described above, the portal server 240 may be configured to invoke the appropriate portlets and aggregate the responses together to create a single markup document returned. In addition to returning markup content, a portlet may return a focus priority for user interface elements included in the content. At step 430, the portal server 240 may determine which user interface element of the portal web page should receive input focus when the portal web page is rendered on a client browser. Depending on the particular portal web page and portlets, the portal server 240 may evaluate the focus priority specified by configuration settings 315 (if any) and the focus priority returned by a portlet (if any), or both to determine which element should receive the input focus. At step 440, the portal server 240 may embed a client-side script in the markup content of the portal web page. The client-side script may be configured to set the input focus on the portal web page to the user interface element determined at step 430. Thereafter, the portal web page may be transmitted as a single markup document to the client system 205 and rendered on client web browser 210.

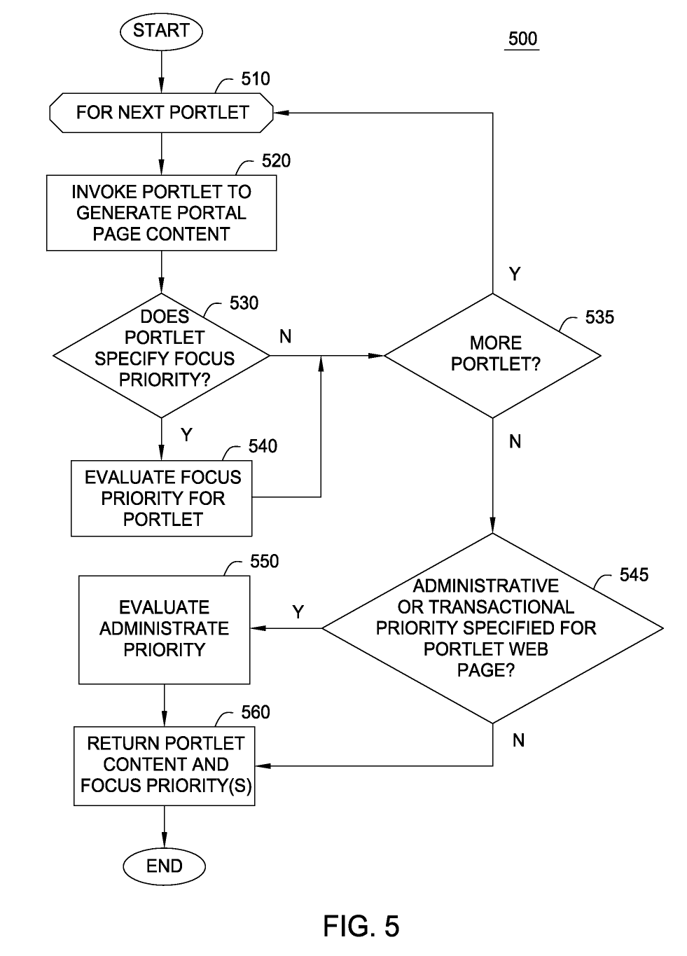

FIG. 5 is flow chart further illustrating a method 500 for responding to a request for a portal web page, according to one embodiment of the invention. As shown, method 500 further illustrates actions that may be performed as part of steps 420 and 430 of the method 400 shown in FIG. 4. The method 500 begins at step 510 where a loop that includes steps 510-540 is repeated for each portlet specified in a portal web page. As described above, a portal web page may reference one or more portlets using JSP tags, or other appropriate markup references, indicating which portlets should be invoked to generate markup content for the portal web page. At step 510, the next portlet is selected. At step 520, the portal server 240 invokes the portlet to generate content for that portal in the portal web page. At step 530, if the portlet returns a focus priority for a user interface element, then at step 535, the priority for the user interface element may be evaluated. For example, the portlet API focus extension 315 described above in reference to FIG. 3 may be used to determine a priority for user interface elements included in that portlet. At step 540, if the portal web page being generated includes more portlets, then the method returns to step 510 where the next portlet on the page is selected and the loop of steps 510-540 is repeated.

At step 545, after content for each portlet on the portal web page is generated, and the focus priority returned by any of the portlets is evaluated, the method 500 proceeds to step 545. At step 545, if the configuration settings 315 for the portal web page being generated specify a user interface element that should received the input focus for the priority web page, or specify a method for determining a focus priority for the portal web page, then the configuration settings 315 may be evaluated at step 550. At step 560, the portal server 240 returns the markup content from for the portal web page along with the input focus priority settings for the portal web page. At the conclusion of the method 500, processing returns to step 430 of the method 400 shown in FIG. 4.

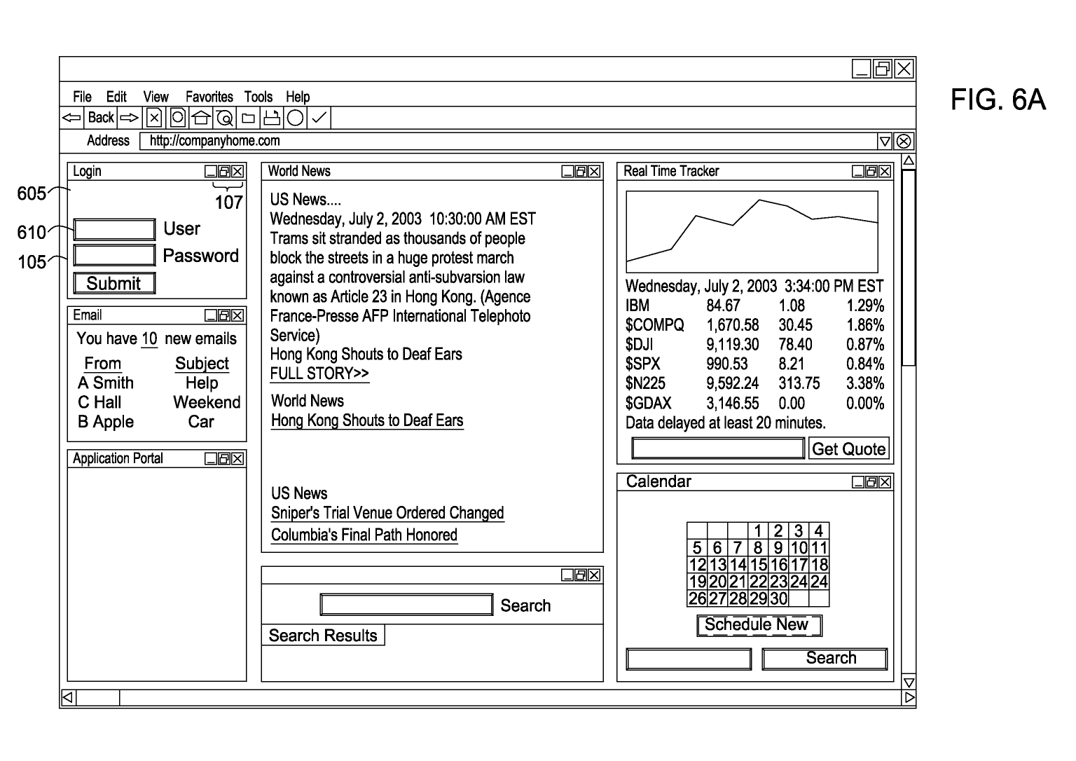

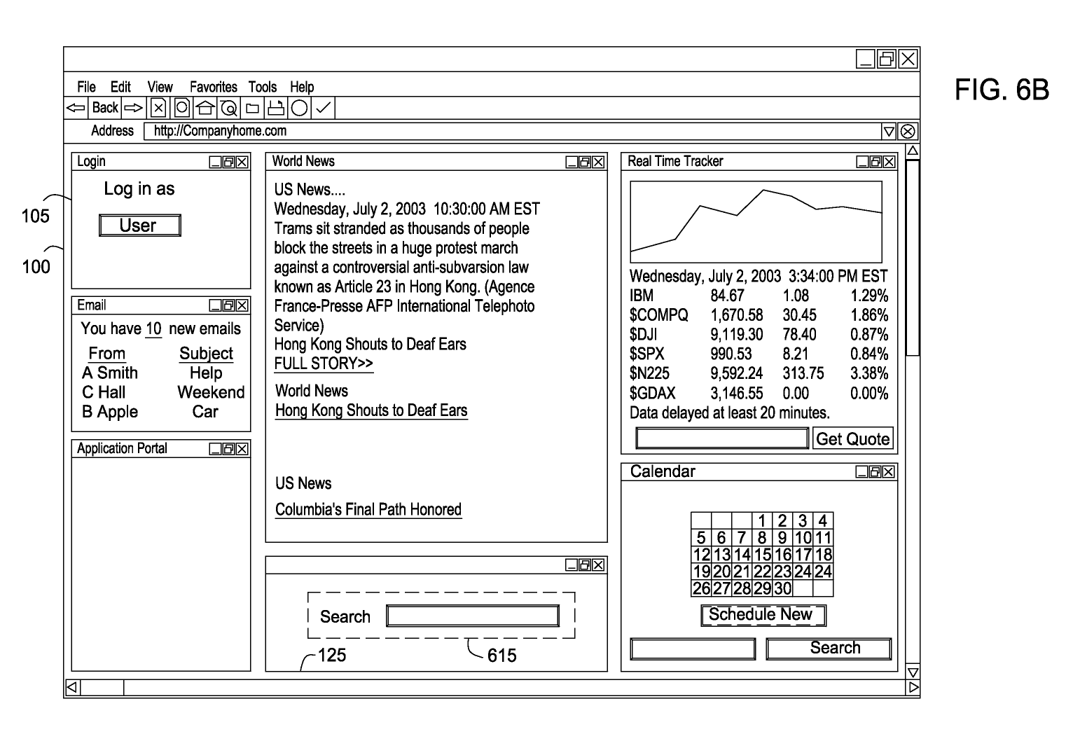

FIGS. 6A-6B illustrate an exemplary portal web page before and after a login transaction performed using a login portlet, according to one embodiment of the invention. FIG. 6A illustrates a rendering of portal web page 100 before a user has logged in to a web application using login portlet 105. As shown, the input focus is set to text box 605 that allows a user to enter a username. The input focus may be set to this user interface element by configuration settings 315. Alternatively, the login portlet 105 may be return a focus priority specifying that if no user is currently logged in, the text box 605 should receive the input focus.

FIG. 6B illustrates a second rendering of portal web page 100 after a user has successfully logged in using login portlet 105. As shown, the content of login portlet 105 now indicates that a user is currently logged in. The input focus for portal web page 100 in FIG. 6B is set to the text field 615 of information search portlet 125. Accordingly, any user input is directed to text field 615 element, without the user having to manually select this user interface element. Like the input focus setting shown in FIG. 6A, the input focus on the text filed 615 may be set by configuration settings 315 or by an evaluation of input focus priorities returned by the portlets included on portal web page 100.

Advantageously, embodiments of the invention allow input focus for portal web pages to be managed in an intuitive manner, consistent with user expectations. Further, this result may be achieved even though the portlets included in a given portal web page may be generally unrelated to one another. As described above, in one general embodiment, which user interface element receives the input focus when a portal web page is rendered may be set administratively using configuration settings of a portal server. In another general embodiment, a portlet may return a focus priority for one of the user interface elements included in that portlet.

While the foregoing is directed to embodiments of the present invention, other and further embodiments of the invention may be devised without departing from the basic scope thereof, and the scope thereof is determined by the claims that follow.

What is claimed is:

1. A method of managing an input focus for user interface elements on a web page, comprising:
retrieving, in response to a request from a client, a requested webpage that includes one or more references to executable components;
generating markup content for each executable component referenced by the requested web page;
aggregating the markup content from each component to form the requested the web page;
determining a user interface element on the requested web page to receive input focus element when the requested web page is rendered; and
embedding a client-side script in the requested webpage configured to set the input focus to the user interface element when the requested web page is rendered.

2. The method of claim 1, further comprising:
transmitting the requested web page to the client;
rendering the requested web page; and
executing the client-side script to set the input focus to the determined user interface element.

3. The method of claim 1, wherein the web page is a portal web page.

4. The method of claim 3, wherein the markup content for each respective executable component is generated by a portlet invoked by a portal server.

5. The method of claim 4, wherein the portlets are composed according to the Java specification request 168 portlet specification.

6. The method of claim 1, wherein determining which user interface element on the requested web page to receive input focus comprises evaluating a focus priority specified for a user interface element in the markup content generated by one of the executable components.

7. The method of claim 1, wherein determining the user interface element on the requested web page to receive input focus comprises evaluating configuration settings specifying a focus priority for a user interface element on the requested web page.

8. The method of claim 1, wherein determining the user interface element on the requested web page to receive input focus, comprises:
evaluating a focus priority specified for a user interface element in the markup content generated by one of the executable components;
evaluating configuration settings specifying a focus priority for a user interface element on the requested web page; and
selecting which user interface element on the requested web page should receive the input focus, based on the evaluation.

9. A computer-readable medium containing a program configured to manage an input focus for user interface elements on a requested webpage which, when executed, performs an operation, comprising:
generating markup content for one or more executable components referenced by the requested web-page;
aggregating the markup content from each executable component to form the requested web page; and
including a focus-designator in the requested webpage, the focus-designator configured to set the input focus to a designated user interface element when rendering the web page.

10. The method of claim 9, wherein the focus designator is an embedded client side script.

11. The computer-readable medium of claim 10, wherein the operation further comprises:
transmitting the requested web page to the client;
rendering the requested web page; and
executing the client-side script to set the input focus to the user interface element.

12. The computer-readable medium of claim 10, wherein the client side script is composed in the javascript scripting language.

13. The computer-readable medium of claim 9, wherein the web page is a portal web page.

14. The computer-readable medium of claim 12, wherein the markup content for each executable component is generated by a portlet invoked by a portal server.

15. The computer-readable medium of claim 14, wherein the portlets are composed according to the Java specification request 168 portlet specification.

16. A computing system, comprising:
a web server configured to receive a request for a web page that includes one or more independent components; and
a portal server configured to:
generate markup content for each executable component included on the requested web page,
aggregate the markup content from each component to form the requested the web page,
determine a user interface element on the requested web page to receive input focus when the requested web page is rendered by the client, and
embed a client-side script in the requested webpage configured to set the input focus to the user interface element when the requested web page is rendered.

17. The computing system of claim 16, wherein the web server is further configured to transmit the requested web page to the client, the client being configured to render the requested web page and execute the embedded client-side script to set the input focus to the user interface element.

18. The computing system of claim 16, wherein the portal server is configured to determine which user interface element on the requested web page to receive input focus by evaluating a focus priority specified for a user interface element in the markup content generated by one of the executable components.

19. The computing system of claim 16, wherein the portal server is configured to determine which user interface element on the requested web page to receive input focus by comprises evaluating configuration settings specifying a focus priority for a user interface element on the requested web page.

20. The computing system medium of claim 16, wherein the portal server is configured to determine which user interface element on the requested web page to receive input focus by:
evaluating a focus priority specified for a user interface element in the markup content generated by one of the executable components;
evaluating configuration settings specifying a focus priority for a user interface element on the requested web page; and
selecting which user interface element on the requested web page should receive the input focus, based on the evaluation.

21. A method for setting an input focus to a user interface element on a web page, comprising:
generating markup content for one or more executable components referenced by the requested web-page;
aggregating the markup content from each executable component to form the web page; and
including a focus-designator in the requested webpage, the focus-designator configured to set the input focus to a designated user interface element when rendering the web page.

22. The method of claim 21, wherein the focus designator is an embedded client side script executed when rendering the web page.

23. A method for deploying computing infrastructure, comprising integrating computer readable code into a computing system, wherein the code in combination with the computing system is adapted to perform the method of claim 1.
